(19) United States
(12) Patent Application Publication
(10) Pub. No.: US 2010/0020166 A1
(43) Pub. Date: Jan. 28, 2010

(54) Environmental hazard warning system

(76) Inventors: Robert Levine, Port Jefferson, NY (US); John Kennedy, JR., Ridge, NY (US)

Correspondence Address: ECKERT SEAMANS CHERIN & MELLOTT, LLC, U.S. STEEL TOWER, 600 GRANT STREET, PITTSBURGH, PA, 15219-2788, US

(21) Appl. No.: 12/316,763

(22) Filed: Dec. 15, 2008

Related U.S. Application Data
(60) Provisional application No. 61/135,939, filed on Jul. 25, 2008.

(51) Int. Cl. H04N 7/18

(52) U.S. Cl. 348/82; 348/E07.085; 348/143

(57) ABSTRACT

A system, including a radiological or other environmental hazard detector, has means to overlay graphical and or alpha numeric text video of the hazard status, alarm annunciation, and or hazard level information, onto the video output of a pre-existing surveillance camera installation. The surveillance camera installation can be fixed or mobile. The system, contained in a field installable module, may utilize power available from the surveillance camera installation. The analog video coaxial cable from the camera is interrupted, such that the video signal is run through the module. This system permits low cost installation of environmental hazard monitoring into an existing analog video surveillance system.

### CROSS-REFERENCE TO RELATED APPLICATION

This application claims priority from the Provisional Patent Application Ser. No. 61/135,939, filed Jul. 25, 2008.

### BACKGROUND OF THE INVENTION

The present invention relates generally to an environmental hazard warning system and, more particularly, to a system that can be inexpensively added to an existing video surveillance system to significantly increase its capability without the cost of installing and monitoring an extensive, stand-alone hazard warning system.

There is active intelligence and concern that terrorists entities are attempting to acquire radioactive sources to construct “dirty bombs” or otherwise use these toxic materials to contaminate public areas, food and/or water supplies. Radiological contamination could cause injury and death to civilians exposed to the event and would result in economic catastrophe for a larger region. It is estimated by some experts that no more than a few curies of radioactive material would contaminate some areas so heavily that decontamination would not be economically feasible. The areas would have to be abandoned and cordoned off, or the buildings would have to be razed with one meter of ground soil being removed to a low-level radioactive waste depository. In addition to a potential health crisis and loss of life, it is quite likely that commerce in the region would be handicapped for an extended period of time, even if the site of a dirty bomb detonation could be cleaned up. Reducing the vulnerability of targets to this type of attack requires enhanced efforts in detecting radiological materials prior to their detonation or dispersal. Proactive measures, such as the deployment of electronic sensors (radiological detectors) in public and high risk areas, are a critical component in any early detection strategy.

This strategy can be particularly effective if it is used to augment surveillance cameras in police and military vehicles as well as public transportation vehicle surveillance systems, including buses and trains. Global Positioning Systems (GPS) have become very inexpensive and simple to implement. Adding GPS information to the video, and recording GPS information along with time and sensor data for post event download, provides additional functionality in mobile applications.

Such a hazard warning system can be designed to covertly or overtly annunciate the presence of radioactive materials breaching the perimeter of the sensor sensitivity range. Radiological sensors are currently available that are capable of this type of detection.

Prior art hazard warning systems are known to display radiation sensor information over video images. U.S. Pat. Nos. 7,126,121 and 7,205,891 to McGlothlin et al. disclose wireless transmission of radiation sensor data to a computer which integrates a video signal from a camera. U.S. Pat. No. 6,633,327 to Williams et al. describes a monitoring system that again combines radiation sensor data with video signals at a computer, and U.S. Pat. No. 7,186,963 to Hughes et al. describes a similar system, but one that can scan the video field of view with the radiation detector and present very specific radiation source information on the video image. These systems were designed for industrial monitoring of nuclear industry sites, where the possibility of accidents is relatively high and the high cost of a dedicated monitoring system is justifiable.

On such dedicated, radiation area monitoring system, which demonstrates the need for combining video surveillance with radiological surveillance, is available commercially from Textron Defense Systems, Goleta, Calif. as an “Adaptable Radiation Area Monitor” or “ARAM.” See www.textrondefense.com.

One of the difficulties with widespread monitoring is that the installation of a wired network of sensors that can adequately detect a radiological threat to a facility or public area can be costly in terms of its installation, the equipment, and the time delay related to planning, funding and implementing such a stand-alone system.

Wireless sensor technology can reduce many installation issues, but it comes with a higher cost of the sensor technology, the wireless repeaters and the central consoles that are required. Wireless technology is also currently viewed as a potential weak point in a security system because the wireless signals can be jammed or otherwise interfered with, thus negating the effectiveness of an early detection sensor network. Consequently, wired signals to a central console represent the most reliable solution for annunciating alarm conditions from remote sensors.

Most facilities and public areas in the United States that are considered to be an attractive target to a terrorist organization have existing security networks in place that use video security cameras to monitor entrance, exits and secure areas. It would thus be desirable to utilize this existing security asset to annunciate an environmental alarm condition by using the existing wired network of security cameras and surveillance protocols.

Better and more cost effective systems are needed that will maximize the use of existing and costly surveillance infrastructure in order to monitor otherwise invisible environmental hazards.

In addition to the need to address terrorist threats, there is a requirement for employee protection in potentially hazardous environments such as chemical plants, biological-related facilities and sources of nuclear materials, where equipment or procedural failures could release life threatening contaminants. Although these facilities typically have video surveillance systems and hazard contaminate monitoring systems in place, adding to this capability would further enhance the early warning and localization of existing hazard monitoring systems. Increased threats and concern for public safety have created a need for increased monitoring of environmental hazards. A means to deploy such monitoring systems quickly and less expensively would be advantageous.

One technique for lowering the cost of, and time to installation would be to utilize the existing monitoring infrastructure. Video surveillance systems are particularly well suited to the addition of environmental hazard capability because (1) the wiring and power supplies are already in place, (2) the monitoring and recording systems and personnel are also in place, and (3) the tying of hazard monitoring to video monitoring affords at least the possibility of viewing the source of the hazard.

The state of the art of hazardous environment detectors has progressed to the point where compact, self-calibrating, stable sensors for chemical, biological and/or radiological detection are now available from commercial sources for relatively low cost.

### SUMMARY OF THE INVENTION

The present invention relates to an environmental hazard warning system that can be readily installed in an existing video surveillance system to remotely annunciate alarm conditions for elevated levels of hazardous materials, such as, but not limited to, radiation in an environment. The system can also store alarm and hazardous sensor level data for later download and analysis. The system is designed to accommodate multiple types of detectors to sense different types of threats, such as, but not limited to radiation and chlorine gas. The system is designed to display a sensed alarm condition as a graphical or alpha-numeric overlay superimposed on a video image. The video information can be added to images obtained from security cameras that are already in position, including mobile applications, thus allowing the system to add new capability into existing security solutions. The system, with its detector(s) and a camera, can also be integrated into a single housing with the camera inside, or installed outside of the existing camera housing. An auditory alarm tone may be generated locally and be remotely applied in tandem with the visual alarm annunciation on the video image.

In a preferred embodiment, the hazard warning system is housed in a weather-proof enclosure forming a hazard sensor alarm unit which can be easily mounted to a surface such as a wall, pole or fence. Another preferred embodiment of the system includes a Global Positioning System (GPS) receiver and can be incorporated into a mobile video surveillance system as might be found in a police or military vehicle or in public transportation. The system has a power input that accepts power typically available to the camera. The system has a video input and a video output. Internally the system may have a sensor or an array of sensors that can be automatically polled on a periodic basis by a microprocessor. The most recent sensor level can be compared to a pre-programmed alarm level to determine if a threat exists. The status of this comparison can be displayed on the existing video image as a graphical representation or as alpha-numeric text. Alarm levels and internal diagnostic modes may be programmed by a simple array of menu switches on the system. In addition or in the alternative, a secure wireless technology may be used to program the system and download historical data in the field. The secure wireless technology is acceptable for this application because it is only used to program a newly installed system or download historical data. Jamming the wireless signal would have no effect on the operation of the system to sense and annunciate an alarm condition once it is operating.

The environmental hazard detector unit according to the invention can be mounted in near proximity to an existing or newly installed video surveillance camera. The environmental hazard detector unit is designed to splice into the power input and the video output of a strategically placed video surveillance camera. The sensor status can be displayed as a video overlay on top of the existing video signal from the surveillance camera. An audio alarm signal can be generated by the sensor box and either mixed in with any existing remote audio surveillance signal or used by itself. A local audio alarm annunciator can be utilized to signal an alarm condition in near proximity to the sensor.

The video image provided by the video camera in concert with the sensor alarm may provide details about who or what is generating the alarm, in addition to just the sensor alarm by itself. This combined visual intelligence with the sensor alarm annunciation allows for a faster more focused response to the threat. The use of existing security assets, such as video and power cabling already in place, significantly reduces the cost, maintenance and installation of the system. Existing video recorders can record the video with the graphical overlay and/or audio alarm signal.

### BRIEF DESCRIPTION OF THE DRAWINGS

FIG. 1 is a block diagram of a first preferred embodiment of the hazard warning system according to the present invention, installed in an existing video surveillance system.

FIG. 2 is a block diagram of a second preferred embodiment of the hazard warning system according to the present invention.

FIG. 3 is a block diagram of a third preferred embodiment of the hazard warning system according to the present invention.

FIG. 4 is a block diagram of a fourth preferred embodiment of the hazard warning system according to the present invention.

FIG. 5 is a block diagram of a fifth preferred embodiment of the hazard warning system according to the present invention.

FIG. 6 is a flow chart showing a preferred embodiment of the algorithm employed in the hazard warning system according to the present invention.

FIG. 7 is a detailed block diagram of a preferred embodiment of the hazard warning system according to the present invention.

FIG. 8 is a mechanical diagram showing the position of the various elements of the hazard warning system according to the invention within a housing.

### DESCRIPTION OF THE PREFERRED EMBODIMENTS

The preferred embodiments of the present invention will now be described with reference to the accompanying drawings. Identical elements represented in the various figures are designated with the same reference numerals.

A typical video surveillance system includes a camera, of which there are usually several, a source of power for the camera, an analog video connection, typically a coaxial cable, and a monitoring station with one or more television monitors or displays and normally a video recording system and an operator who monitors the surveillance camera images utilizing the monitors and playback capability of the video recorders.

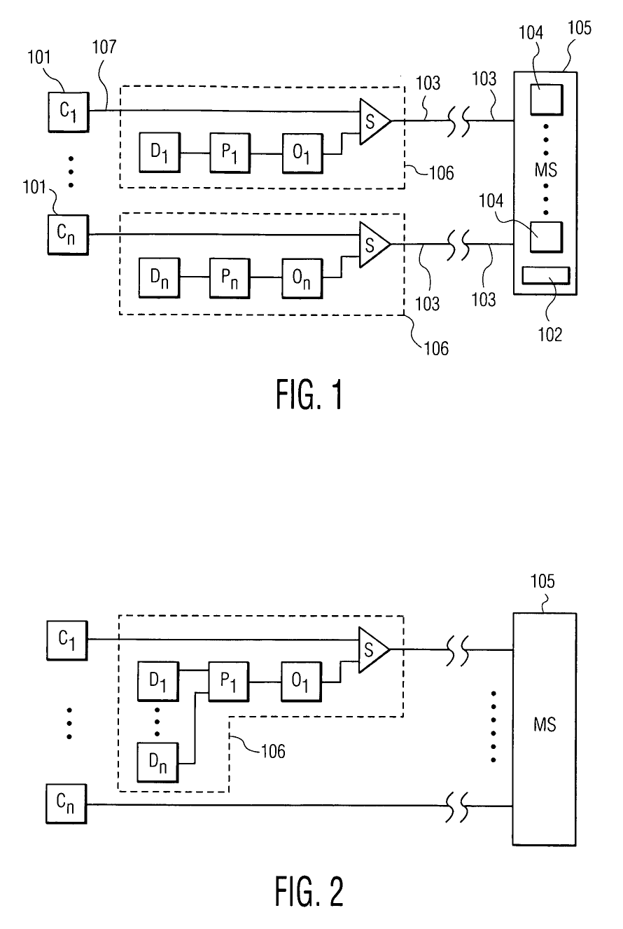

FIG. 1 illustrates such a typical system, but with the addition of a hazard warning unit according to the present invention. The environmental hazard warning unit may or may not utilize the power source from the camera and interrupts the analog video cable through a simple cable splice.

The closed circuit television (CCTV) surveillance system, in its simplest form, consists of a CCTV camera 101 and a CCTV monitoring station 105. Typically there is a video recorder and multiplexer 102 that can accept multiple video signals from multiple cameras 101 and record the video signals for later review. Each camera 101 is typically supplied 12VDC or 24VAC power and transmits video in a standard format (PAL or NTSC) through a 75 ohm coaxial cable 103 to the video monitoring station 105. A more complex surveillance system usually has a plurality of CCTV cameras 101 and CCTV monitors 104 and possibly multiple video recorder and multiplexers 102. This type of system can be installed both in stationary facilities as well as in vehicles. This state of the art is well established and a form of this type of system is installed in countless numbers and locations throughout the world.

FIG. 1 also illustrates the system according to the present invention whereby the existing video surveillance system is significantly enhanced with the addition of the Environmental Hazard Detector (EHD) 106 installed between the CCTV camera 101 and the video monitoring station 105. The coaxial cable 103 is removed (or cut and spliced) from the CCTV camera and attached to the (EHD) unit 106. A section of coaxial cable 107 is connected between the CCTV camera 101 to the EHD unit 106 to complete the video circuit. Some systems may accommodate a separate audio channel. In this case the audio signal would be spliced into the circuit in a similar manner. Power for the EHD unit 106 is spliced off the CCTV power supply utilizing weather-proof electrical splices provided with an installation kit. Note that except for video and power, the existing CCTV surveillance system is not physically altered. Splicing power off of the camera is the preferred method of installation because the camera power is typically sourced from a power supply with a battery backup, thus keeping the EHD operating if building AC power is lost. If the existing camera power system cannot accommodate the EHD, then a separate 12VDC or 24VAC power source can be installed.

The EWD unit 106 comprises an environmental hazard detector D for sensing the presence of an environmental hazard, be it chemical, biological and/or radiological. This detector D produces a signal representing the status or level of an environmental hazard and passes it to a processor P. If the status signal is in analog form, it is amplified, conditioned and passed through an analog-to-digital conversion before application to the processor P. If the hazard detector D is intelligent, it can perform the necessary conditioning and analog-to-digital conversion and pass the digital data to the processor P.

The processor P receives the hazard status signal and determines the level of environmental hazard which may, for example, be a simple number on an arbitrary number scale. The processor produces a data signal representing this number (the level of environmental hazard) and passes this data signal to a video overlay circuit O. The overlay circuit receives the data and produces an overlay display, represented in text or graphics or both, indicating the level of the environmental hazard. Finally, the output of this overlay circuit O is passed to a video combiner circuit S which receives both the video image signal produced by the camera 101 and the overlay display signal from the overlay circuit O and produces a composite video signal representing both the video image of the scene and the overlay display showing the level of the environmental hazard, for transmission to the video monitoring station 105.

FIG. 2 shows a second preferred embodiment of the EHD unit wherein the processor P accepts inputs from a plurality of detectors D1, . . . D_{N}. These detectors may all be of the same type—e.g., radiation detectors—disposed at different locations within the field of view of camera C1, or they may be different types of detectors such as a radiation detector, toxic chemical detector and/or a detector designed to sense a particular biological vector.

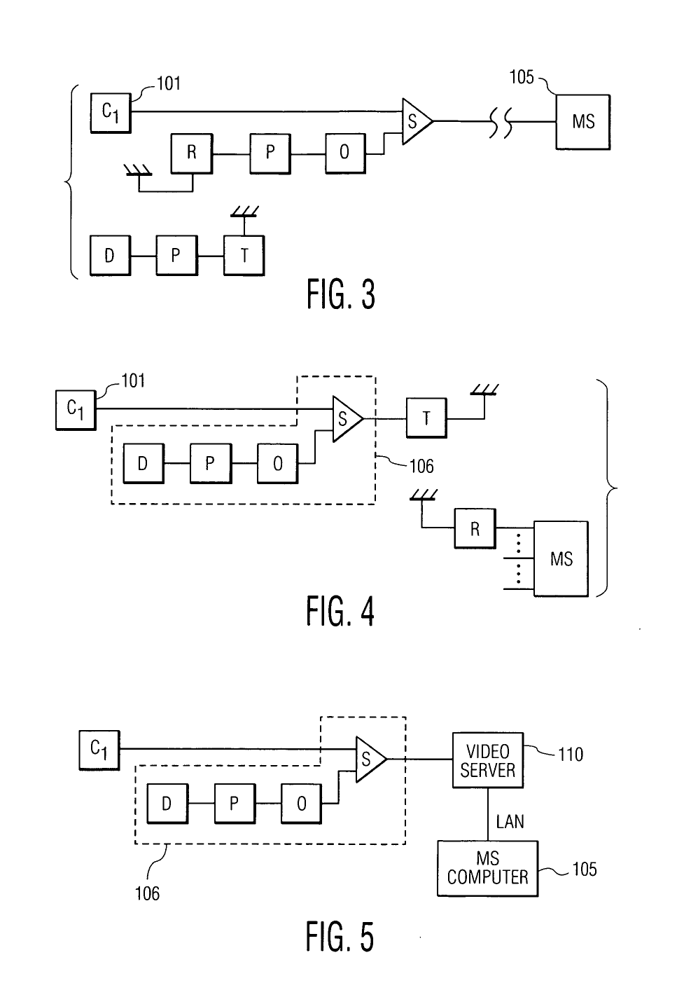

FIG. 3 illustrates a preferred embodiment wherein the output of the processor P is transmitted wirelessly, e.g., via a Bluetooth link, by a transmitter T to a receiver R connected to the overlay circuit O which is adjacent to or integrated with the combiner circuit S. In this case, the transmitter T, which receives the data signal representing the environmental hazard from the processor P and the detector D, are preferably disposed in the immediate vicinity of the camera C.

FIG. 4 illustrates another configuration of a wireless system wherein the EHD unit 106 supplies the video signal combined with the video overlay and the audio signal combined with the audio alarm signal to a transmitter T which, in turn, transmits the combined video and audio signals to a receiver R connected to the monitoring station 105.

FIG. 5 shows still another embodiment wherein the output of the EHD unit 106 is supplied to a video server 110 which converts the analog video signal to a digital IP protocol for placement on a local area network. The video images are then stored in, and displayed by, a computer at the monitoring station 105. An IP based surveillance system is advantageous for new installations which already have a network wired within the building.

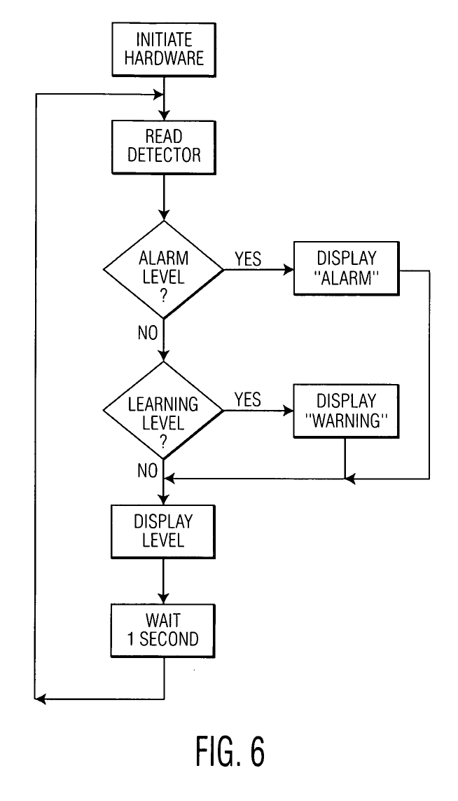

As illustrated by the flow chart of FIG. 6, the processor P of the EHD unit 106 carries out a simple, repetitive task. It reads the output of the detector D and determines whether the level indicates an environmental hazard. If the output level exceeds the user programmable alarm level, the processor P passes an “alarm” message to the overlay circuit O.

Assuming that the detector D produces a proper level signal, the processor P determines whether the level indicates an environmental warning condition exists. If the output level exceeds the user programmable warning level, the processor passes this level information to the overlay circuit O together with a “warning” status signal.

Thereafter, the processor P waits one second and loops back to read the detector D again.

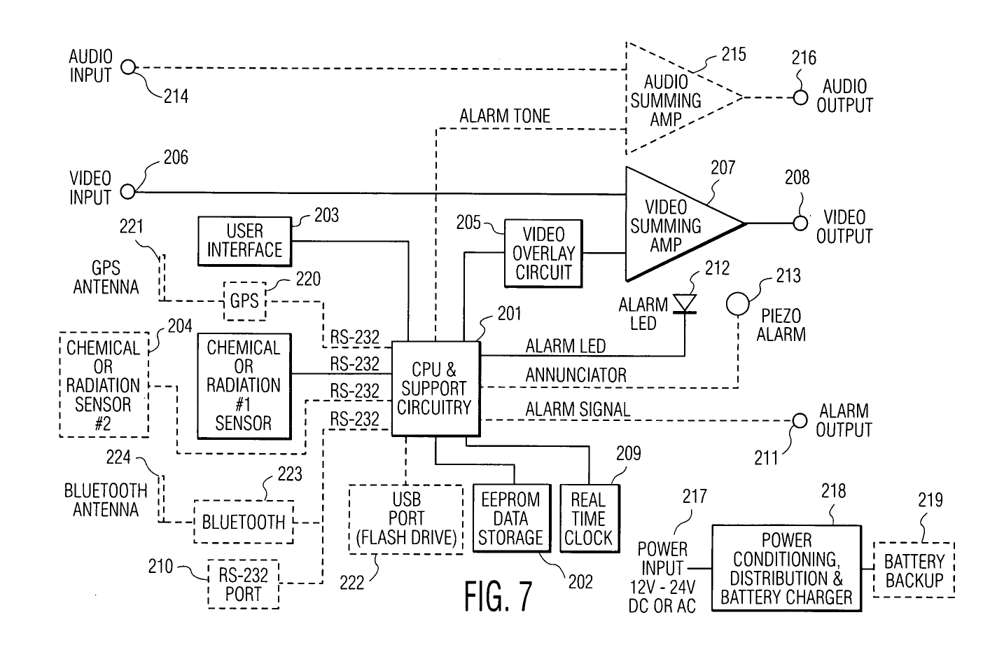

FIG. 7 shows the basic features of a preferred embodiment of the invention. Optional functionality features are shown as dashed lines and dashed blocks in the figure.

The system is designed to easily mount to an external or internal surface in near proximity to a video security camera and to utilize the camera's power and video signals. The system is packaged in a tamper-resistant and weather-resistant housing so that it can withstand the elements when mounted outdoors. The detectors are polled by the processor (CPU) for their current sensor levels. Ambient levels are recorded to establish a baseline for an area. The most recent sensor data is compared to pre-programmed levels measured above ambient to determine if they exceed an alarm threshold. The microprocessor could be set at the factory or in the field by utilizing a simple push button keypad that would allow various sensing parameters such as, but not limited to, alarm levels, sampling time, time, date, etc. The system can incorporate a real-time clock and non-volatile memory to record extended periods of sensor data for later download and analysis. The system can also be programmed by using a computer or PDA using a hard wire connection such as, but not limited to, RS232, Universal Serial bus (USB) or a wireless mechanism such as, but not limited to, Bluetooth.

The video signal that is sourced by the video camera passes through a circuit that allows the microprocessor to display sensor data and alarm conditions as a video overlay on top of the video image. This combined image is then output to the existing video connections that would typically be monitored at a central security check point. The security checkpoint is typically equipped with an array of monitors that display the video from the security cameras. If an audio signal is involved it would pass through the sensor system as well.

Under normal, non-alarm, operating conditions the sensor display can display the ambient sensor readings over the existing video signal. In the event of an alarm condition, the video overlay annunciates the condition with a conspicuous display that alerts the security personnel. An audio signal could also be generated and mixed into the existing audio surveillance signal, if one is available, to provide additional notification to security personnel. Local annunciation of the alarm condition could be accomplished with an audio alert tone generated by an oscillator and output through a Piezo-audio transducer or speaker. LED's could also be utilized on the sensor module to indicate that it is in an alarm state.

Referring now in detail to the block diagram of the EHD unit 106 in FIG. 7, this unit is packaged into a compact, weatherproof enclosure that can be readily mounted to a structure in proximity of the CCTV surveillance camera 101. The minimum practical system consists of a microprocessor or Central Processing Unit (CPU) 201 which accepts, processes, and distributes data to the other functional blocks of the system. The CPU 201 contains Random Access Memory (RAM), non volatile memory for firmware and programmable parameters, as well as timers. A real time clock 209 can be implemented as either part of the CPU module or as a standalone device. The real time clock 209 is utilized to time stamp any data being recorded for later download and analysis. An open RS232 port 210 is utilized for hard wire communication to the CPU 201 for programming and data download. This function can also be performed through a Bluetooth wireless interface 223 if this functionality is optionally included. The Bluetooth radio module 223 communicates with the CPU 201 via an RS232 or similar interface and requires a separate radio antenna 224 which in the case of metal enclosure would be mounted to the outside of the enclosure. The Bluetooth antenna 224 could be mounted internally in an RF transparent enclosure. A simple user interface 203 consisting of 4 push button switches which navigate an on screen menu system can be used to program parameters in the firmware program and the sensor 204 set up parameters. One or more chemical or radiation sensors 204 communicate hazard level data to the CPU 201 via a RS232 or similar interface. In the case of a gamma radiation sensor, the EHD enclosure does not cause a significant attenuation of gamma radiation exposure to the sensor inside the enclosure. In the case of chemical hazard sensors, the sensor may require venting to the outside of the enclosure or itself be mounted to the outside of the EHD enclosure so as to maximize sensor exposure to the environment. Once an alarm condition has been established by the CPU 201, there are several means to communicate this information. The primary means is by overlaying text and graphics to the camera video input 206 by means of the video overlay circuit 205 and a video summing amplifier 207. This combined video is then output (video output) 208 from the EHD 106 via the coaxial cable 103 and ultimately to the CCTV monitor 104. Some existing surveillance systems may incorporate audio surveillance microphones as part of the system. In this case an alarm tone can be generated by the CPU 201 and summed with an audio input 214 utilizing an audio summing amplifier 215 and outputting the combined signal to an audio output 216 for transmission back to the security office. Locally, the EHD module 106 also has an LED illuminator 212 to indicate an active alarm condition, a Piezo audible alarm 213 to indicate an alarm condition and an alarm voltage output 211 that can be used to trigger a device such as a loud speaker and or a bright light or rotating light to locally and definitively annunciate an alarm condition. Actual hazard sensor data, logged together with times from the real time clock is stored onto a EEPROM 202. The data stored on this EEPROM can be downloaded utilizing the RS232 port 210 or the Bluetooth wireless interface 223. The EEPROM 202 has limited capacity to store data. When large amount of data storage are required or if it is desirable for the data storage medium to be readily removable, a USB interface 222 is provided that can accept a standard USB flash drive to which the CPU 106 can write large numbers of data files to.

When utilizing the system for mobile applications, a GPS receiver 220 and GPS antenna 221 are utilized to provide location information to both the video overlay and to all data storage media. The GPS antenna connection is typically outside of the enclosure so that the GPS antenna 221 can be best located to be able to receive satellite data. In mobile applications, the Bluetooth interface 223 can be utilized to automatically download and interrogate data collected by the vehicle mounted system on a regular basis.

This would be most useful at the end of a shift or during return to a depot for regular refueling, maintenance or storage, etc. The downloaded data would be interrogated for any alarm conditions. If an alarm condition was present, the data could be further reviewed for location and time of the alarm and specific measured levels of hazard conditions.

Power 217 can come in several forms including 12VDC or 24VAC nominal and can range significantly from nominal values. Input power is conditioned and supplied to the various internal components of the EHD unit 106 by the power conditioning module 218. This module also includes circuitry for charging a backup battery 219 and for supplying power to the EHD 106 as well as supplying 12VDC power to the surveillance camera 101 should there be a local power interruption.

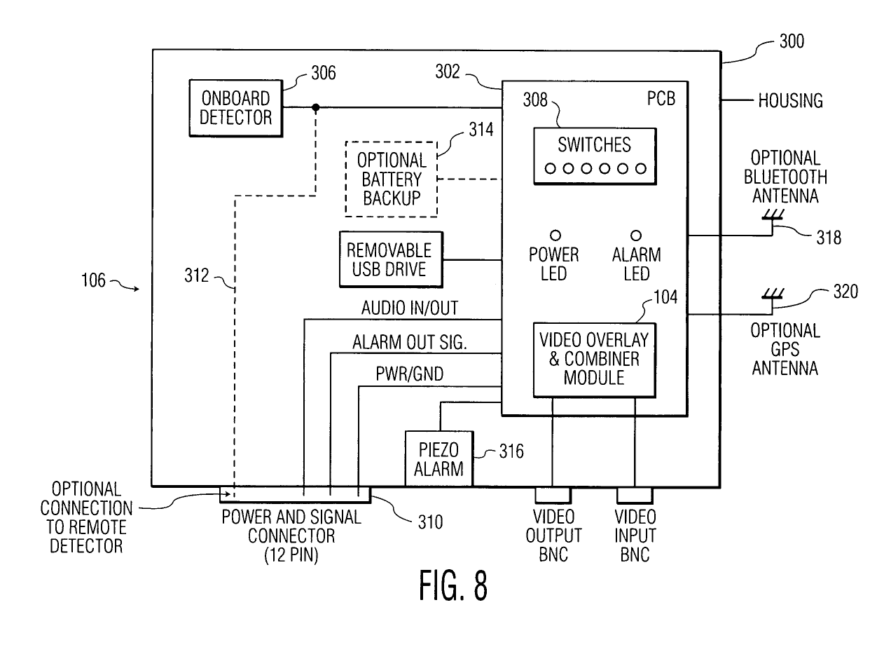

FIG. 8 shows how these various elements are physically combined and packaged in a metal or plastic housing 300. As is shown there, a printed circuit board 302, which carries the processor P and a module 304 with the video overlay circuit O and the combiner circuit S, is disposed in the weather-proof housing together with an onboard detector D 306. The PCB 302 carries four menu switches 308 for selecting parameters as explained above.

The detector D 306 can either be disposed within the housing or arranged remotely of the housing. In the latter case, the detector D is connected to the system by an external jack and an internal wire 312, shown in dashed lines.

Optionally, the housing may be provided with a battery back-up circuit 314.

The twelve pin connector of the jack 310 supplies power, between a power lead and ground, and serves to provide an input/output for audio and an output for an alarm signal.

A piezo alarm output 316 and optional Bluetooth and GPS antennae 318 and 320, respectively, complete the EHD unit 106.

There has thus been shown and described a novel environmental warning hazard system which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Environmental hazard monitoring and warning apparatus adapted for use with an existing surveillance system infrastructure that includes at least one video camera for producing, at a video camera output, a video image signal representing a video image of a scene that is under surveillance, and a remote video monitoring station, coupled to said video camera output, for receiving the video image signal and displaying the video image of the scene, said hazard monitoring apparatus comprising, in combination:
(a) an environmental hazard detector for sensing the presence of an environmental hazard and producing a hazard status signal in response thereto;
(b) a processor, coupled to said environmental hazard detector, for receiving said hazard status signal and determining a level of the environmental hazard in response thereto, said processor producing a data signal representing the level of the environmental hazard;
(c) a video overlay circuit, coupled to said processor, for receiving said data signal and producing an overlay display signal in response thereto representing an overlay display containing at least one of text and graphics stating the level of the environmental hazard; and
(d) a video combiner circuit, having inputs adapted to be coupled to said video camera output and to said video overlay circuit, respectively, and an output adapted to be coupled to said video monitoring station, for receiving said video image signal and said overlay display signal and producing, at the video combiner circuit output, a composite video signal, representing both said video image of the scene and said overlay display stating the level of the environmental hazard, for transmission to said video monitoring station.

2. The environmental hazard monitoring apparatus defined in claim 1, further comprising a video cable, connecting said video camera output and said video monitoring station, for transmitting said video image signal from said video camera to said video monitoring station, wherein said video combiner circuit is adapted to be connected into said video cable between said video camera output and said video monitoring station.

3. The environmental hazard monitoring apparatus defined in claim 1, further comprising a video cable, connecting said video camera output and said video monitoring station, for transmitting said video image signal from said video camera to said video monitoring station, wherein said video combiner circuit is adapted to be connected into said video cable between said video camera output and said video monitoring station, said apparatus further comprising a wireless transmitter connected to an output of said processor and a wireless receiver, connected to an input of said overlay circuit, for providing said data signal representing the level of the environmental hazard from said processor to said overlay circuit.

4. The environmental hazard monitoring apparatus defined in claim 1, further comprising a wireless transmitter, connected to the output of said video combiner, and a wireless receiver, connected to an input of said video monitoring station, for providing said composite video signal, representing both said video image of the scene and said overlay display stating the level of the environmental hazard, to said video monitoring station.

5. The environmental hazard monitoring apparatus defined in claim 1, wherein said surveillance system infrastructure further includes at least one audio sensor for producing, at an audio sensor output, an audio monitoring signal representing environmental sounds at a given location that is under surveillance; wherein said video monitoring station is coupled to said audio sensor output and is operative to receive said audio monitoring signal and audibly reproduce the environmental sounds; wherein said processor produces a hazard warning signal representing a warning sound in response to an unacceptable level of environmental hazard; and wherein said hazard monitoring apparatus further includes an audio combiner circuit, having inputs coupled to said audio sensor output and to said processor, respectively, and an output coupled to said video monitoring station, for receiving said audio monitoring signal and said hazard warning signal and producing, at said audio combiner circuit output, a composite audio monitoring and hazard warning signal, representing the environmental sounds at said location and said warning sound, for transmission to said monitoring station.

6. The environmental hazard monitoring apparatus defined in claim 1, wherein said surveillance system infrastructure includes a plurality of video cameras, each connected to said monitoring station, and said hazard monitoring apparatus includes a plurality of environmental hazard detectors, each associated with, and located adjacent to, one of said video cameras.

7. The environmental hazard monitoring apparatus defined in claim 1, wherein said environmental hazard detector is selected from the group consisting of a chemical hazard detector, a biological hazard detector and a radiological hazard detector.

8. The environmental hazard monitoring apparatus defined in claim 1, further comprising a weather-resistant housing for said processor, said video overlay circuit and said video combiner circuit, said housing and its contents forming part of an installation kit adapted to be installed in an existing video surveillance system.

9. The environmental hazard monitoring apparatus defined in claim 8, wherein said housing has an input jack, connected to said processor, for connecting said environmental hazard detector.

10. The environmental hazard monitoring apparatus defined in claim 1, further comprising a weather-resistant housing for environmental hazard detector, said processor, said video overlay circuit and said video combiner circuit, said housing and its contents forming part of an installation kit adapted to be installed in an existing video surveillance system.

11. The environmental hazard monitoring apparatus defined in claim 1, further including a non-volatile memory and a real time clock connected to said processor for locally storing historical environmental hazard data.

12. The environmental hazard monitoring apparatus defined in claim 1, further comprising a Global Positioning System (GPS) receiver connected to the processor, and wherein said data signal includes GPS location information for inclusion in said overlay display signal.

13. The environmental hazard monitoring apparatus defined in claim 2, further comprising a Global Positioning System (GPS) receiver connected to the processor, and wherein said data signal includes GPS location information for inclusion in said overlay display signal.

14. The environmental hazard monitoring apparatus defined in claim 3, further comprising a Global Positioning System (GPS) receiver connected to the processor, and wherein said data signal includes GPS location information for inclusion in said overlay display signal.

15. The environmental hazard monitoring apparatus defined in claim 4, further comprising a Global Positioning System (GPS) receiver connected to the processor, and wherein said data signal includes GPS location information for inclusion in said overlay display signal.

16. The environmental hazard monitoring apparatus defined in claim 1, further including a battery back-up power source connected to said processor, said overlay circuit and said combiner circuit, and adapted to be connected to said video camera.

17. The environmental hazard monitoring apparatus defined in claim 1, further comprising a Bluetooth transmitter and receiver, connected to said processor, for Bluetooth communication with a remote control unit.

18. The environmental hazard monitoring apparatus defined in claim 1, further comprising a video server, connected to the video combiner, for producing a composite digital television signal representing both said video image of the scene and said overlay display stating the level of the environmental hazard, for transmission to a computer at said video monitoring station.
